(19) United States
(12) Patent Application Publication
(10) Pub. No.: US 2004/0242159 A1
(43) Pub. Date: Dec. 2, 2004

(54) Interoperability and coexistence between two disparate communication systems

(76) Inventors: Roberto Calderon, Perkiomenville, PA (US); Wilhelmus Diepstraten, Haghorst (NL); John N. MacDonald, Oley, PA (US); Ying Shen, Center Valley, PA (US); Steven E. Strauss, Orefield, PA (US)

Correspondence Address: MANELLI DENISON & SELTER PLLC, 7th Floor, 2000 M Street, N.W., Washington, DC, 20036-3307, US

(21) Appl. No.: 10/445,896

(22) Filed: May 28, 2003

(51) Int. Cl. H04B 1/38; H04M 1/00

(52) U.S. Cl. 455/63.3; 455/552.1

(57) ABSTRACT

Combined IEEE 802.11 (WiFi) and Bluetooth transceiver and method of operation employing busy signals to monitor when transmissions of each type are being transmitted or received, and employing a synchronizing signal to synchronize the use of time slots. In one embodiment, a simple two-wire interface is exposed linking Bluetooth and IEEE 802.11 radio systems. In another embodiment, the Bluetooth and IEEE 802.11 services can exchange information including scheduling, mode of operation, channel usage and device state via a shared resource such as a memory, referred to as a ‘mailbox’.

This application claims priority from U.S. Appl. No. 60/245,894, filed Nov. 13, 2002, entitled “Interoperability and Co-Existence Considerations in IEEE 802.11 and Bluetooth Communication Systems,” the entirely of which is expressly incorporated herein by reference.

### BACKGROUND OF THE INVENTION

1. Field of the Invention

The invention relates to interoperability and coexistence mechanisms in a communication system integrating two different wireless radio systems. More particularly, the invention provides a method and system for minimizing or preventing local and network interference while transmitting and receiving addressed packets between two disparate wireless services (e.g., Bluetooth and IEEE 802.11) by providing real-time hardware-based signaling interfaces.

2. Background of Related Art

Wireless systems typically operate in a common medium—the air. To avoid interference between various systems, frequency bands are typically assigned for operation by particular wireless systems. However, wireless systems are very popular, and thus most useable frequency bands are already assigned. As technology pushes forward, higher and higher frequencies are becoming more and more useful.

Nevertheless, the crowded frequency bands inevitably lead to closeness of operation between various wireless systems. While perhaps bearable in most ordinary situations, when placement of such competing wireless systems within a common system, and even into a common device and/or onto a common printed circuit board, interference issues between disparate wireless systems becomes a difficult issue to suitably avoid.

Such is the case between the wireless system IEEE 802.11, more commonly known as “Wireless LAN” or “WiFi,” and a quickly emerging wireless piconet system known as Bluetooth™. First, some background into the nature and operation of both WiFi and Bluetooth.

WiFi, or IEEE 802.11, is a standard for wireless systems that operates in the 2.4-2.5 GHz ISM (industrial, scientific and medical) band. This ISM band is available world-wide and allows unlicensed operation for spread spectrum systems. For both the US and Europe, the 2,400-2,483.5 MHz band has been allocated, while for some other countries, such as Japan, another part of the 2.4-2.5 GHz ISM band has been assigned. The 802.11 standard focuses on the MAC (Medium Access Control) protocol and PHY (Physical Layer) protocol for Access Point (AP) based networks and ad-hoc networks.

In Access Point based networks, the stations within a group or cell can communicate only directly to the Access Point. This Access Point forwards messages to the destination station within the same cell or through a wired distribution system to another Access Point, from which such messages arrive finally at the destination station. In ad-hoc networks, the stations operate on a peer-to-peer level and there is no Access Point or (wired) distribution system.

The 802.11 standard supports: DSSS (direct sequence spread spectrum) with differential encoded BPSK and QPSK; FHSS (Frequency Hopping Spread Spectrum) with GFSK (Gaussian FSK); and infrared with PPM (Pulse Position Modulation). These three physical layer protocols (DSSS, FHSS, and infrared) all provide bit rates of 2 and 1 Mbit/s. The 802.11 standard further includes extensions 11a and 11b. Extension 11b is for a high rate CCK (Complementary Code Keying) physical layer protocol, providing bit rates 11 and 5.5 Mbit/s as well as the basis DSSS bit rates of 2 and 1 Mbit/s within the same 2.4-2.5 GHz ISM band. Extension 11a is for a high bit rate OFDM (Orthogonal Frequency Division Multiplexing) physical layer protocol standard providing bit rates in the range of 6 to 54 Mbit/s in the 5 GHz band.

The 802.11 basic medium access behavior allows interoperability between compatible physical layer protocols through the use of the CSMA/CA (Carrier Sense Multiple Access with Collision Avoidance) protocol and a random back-off time following a busy medium condition. In addition all directed traffic uses immediate positive acknowledgement (ACK frame), where a retransmission is scheduled by the sender if no positive acknowledgement is received. The 802.11 CSMA/CA protocol is designed to reduce the collision probability between multiple stations accessing the medium at the point in time where collisions are most likely to occur. The highest probability of a collision occurs just after the medium becomes free, following a busy medium. This is because multiple stations would have been waiting for the medium to become available again. Therefore, a random back-off arrangement is used to resolve medium contention conflicts. In addition, the 802.11 MAC defines: special functional behavior for fragmentation of packets; medium reservation via RTS/CTS (Request-To-Send/Clear-To-Send) polling interaction; and point co-ordination (for time-bounded services).

The IEEE 802.11 MAC also defines Beacon frames, sent at a regular interval by an AP to allow Stations (STAs) to monitor the presence of the AP. IEEE 802.11 also defines a set of management frames including Probe Request frames which are sent by an STA, and are followed by Probe Response frames sent by the AP. Probe Request frames allow an STA to actively scan whether there is an AP operating on a certain channel frequency, and for the AP to show to the STA what parameter settings this AP is using.

The other exemplary wireless system, Bluetooth, allows for the replacement of the many proprietary cables that connect one device to another with one universal short-range radio link. For instance, Bluetooth radio technology built into both a cellular telephone and a laptop would replace the cumbersome cable used today to connect a laptop to a cellular telephone. Printers, Personal Digital Assistant's (PDA's), desktops, computers, fax machines, keyboards, joysticks and virtually any other digital device can be part of the Bluetooth system. But beyond un-tethering devices by replacing the cables, Bluetooth radio technology provides a universal bridge to existing data networks, a peripheral interface, and a mechanism to form small private ad-hoc groupings of connected devices away from fixed network infrastructures.

Designed to operate in a noisy radio frequency environment, the Bluetooth radio system uses a fast acknowledgement and frequency hopping scheme to make the link robust. Bluetooth radio modules avoid interference from other signals by hopping to a new frequency after transmitting or receiving a packet. Compared with other systems operating in the same frequency band, the Bluetooth radio system typically hops faster and uses shorter packets. Short packets and fast hopping also limit the impact of domestic and professional microwave ovens. Use of Forward Error Correction (FEC) limits the impact of random noise on long-distance links. The encoding is optimized for an uncoordinated environment. Bluetooth radios operate in the unlicensed ISM band at 2.4 GHz. A frequency hop transceiver is applied to combat interference and fading. A shaped, binary FM modulation is applied to minimize transceiver complexity. The gross data rate is 1 Mb/s.

A Time-Division Duplex scheme is used for full-duplex transmission. The Bluetooth baseband protocol is a combination of circuit and packet switching. Slots can be reversed for synchronous packets. Each packet is transmitted in a different hop frequency. A packet nominally covers a single slot, but can be extended to cover up to five slots. Bluetooth can support up to seven simultaneous asynchronous data channels, up to three simultaneous synchronous voice channels, or a channel that simultaneously supports asynchronous voice. Each voice channel supports 64 kb/s synchronous (voice) link. The asynchronous channel can support an asymmetric link of maximally 721 kb/s in either direction while permitting 57.6 kb/s in the return direction, or a 432.6 kb/s symmetric link.

The IEEE 802.11 standard is already well-established, with local area networks implemented based on the standard. However, as Bluetooth emerges in the market, it is likely to be implemented in a domestic environment for communications within the home.

Since both Bluetooth and IEEE 802.11 both operate in the 2.4 GHz ISM band, they have the opportunity to interfere with each other and cause degraded performance to each independent technology. Compounding a coexistence problem would be target products having two disparate wireless technologies co-located. Co-location is defined as having the transmitters, receivers, and antennas physically close together with poor isolation. This occurs when, e.g., they are both physically inside the same PC, or other similar product.

Thus, for example, someone with a lap-top computer may wish to connect to a IEEE 802.11 wireless local area network in the workplace, and connect to a device, such as a mobile telephone, using a Bluetooth interface outside of the workplace. Though WiFi and Bluetooth do not operate at identical frequencies, they are close enough in frequency that interference becomes an issue when placed in close proximity to one another.

Thus, a need exists to reduce interference between disparate wireless systems operating in a common airspace, e.g., between WiFi and Bluetooth, to enable successful integration of both.

### SUMMARY OF THE INVENTION

In accordance with the principles of the present invention, a method is provided to avoid transmission interference between a first wireless system operating at a first range of frequencies of operation and a second wireless system operating at a second range of frequencies of operation. The first wireless system and the second wireless system are co-located. Radio status information is passed from the first wireless system to the second wireless system. Transmission by the second radio system is delayed based on medium status information provided by the first wireless system. One of the first wireless system and the second wireless system transmits in RF time slots. Concurrent radio transmission by both the first wireless system and the second wireless system are avoided.

In accordance with another aspect of the present invention, a method and apparatus incorporates a first wireless system operating at a first range of frequencies of operation and a second wireless system operating at a second range of frequencies of operation. The first wireless system and the second wireless system are co-located. A first busy signal is provided by the first wireless system to the second wireless system over a direct communication link indicating a timing of a reception on the first wireless system. A second busy signal provided by the second wireless system to the first wireless system over a direct communication link indicates a timing of a reception on the second wireless system. A controller is responsive to the first busy signal. The controller is configured to cause the second wireless system to delay transmission due to an active transmission state of the first wireless system. One of the first wireless system and the second wireless system transmits in RF time slots.

### BRIEF DESCRIPTION OF THE DRAWINGS

Features and advantages of the present invention will become apparent to those skilled in the art from the following description with reference to the drawings, in which:

FIG. 1 shows a block diagram of one embodiment of a direct communication link established between two co-located wireless services, e.g., a Bluetooth system and an WiFi (IEEE 802.11), in accordance with the principles of the present invention.

FIG. 2 shows exemplary signal timing of an exemplary WLAN Medium Busy (WLMBsy) signal, in accordance with the principles of the present invention.

FIG. 3 shows timing of an exemplary Bluetooth BTMBsy signal while operating in asynchronous mode, in accordance with the principles of the present invention.

FIG. 4 shows exemplary synchronous signal timing of a Bluetooth BTSYNC signal, in accordance with the principles of the present invention.

FIG. 5 shows characteristics of an exemplary BTDATAVALID signal, in accordance with the principles of the present invention.

FIG. 6 shows characteristics of an exemplary BTDATAVALID signal indicating when IEEE 802.11 (WiFi) data is valid, in accordance with the principles of the present invention.

FIG. 7 shows an exemplary IEEE 802.11 radio system and Bluetooth baseband equipment including an exemplary hard-wired interface (e.g., a 2-wire interconnect), in accordance with the principles of the present invention.

### DETAILED DESCRIPTION OF THE ILLUSTRATIVE EMBODIMENTS

The present invention provides communication between disparate wireless services, e.g., an IEEE 802.11 MAC (Wireless LAN MAC or WMAC) and a Bluetooth Baseband/MAC, to inform the other regarding radio status, facilitating operable coexistence between the two technologies. The communication between the co-located wireless services avoids the condition that one wireless service would be transmitting at the same time that another co-located wireless service is receiving. In some applications, direct communication between the two wireless service front ends may be coordinated and planned in an RF time slot wireless system such as a piconet, to avoid the condition where one wireless service will need to receive while the other is transmitting.

In one embodiment the present invention provides real-time hardware-based signaling interfaces between two co-located disparate wireless services, such as Bluetooth and IEEE 802.11. This hard-wired interface is provided to allow each service to inform the other of the active state of it's radio front end. In another embodiment, a bi-directional or shared resource such as a mailbox is employed to pass local messages containing real-time status information to the other wireless service, again allowing coordination and avoidance of the undesirable condition of one wireless service transmitting while the other is receiving.

Direct communication between the wireless services allows control of data transmissions from the respective wireless services, and provides a way to minimize and even prevent entirely local and network interference while transmitting and receiving addressed packets within each of the two disparate services.

The present invention includes improvements over published US Patent Application 2001/10689 A1 to Awater et al., the entirely of which is expressly incorporated herein by reference.

Assuming close proximity, it has been demonstrated through analytical and laboratory analysis that having either system transmit during periods of active reception of the other service tends to seriously degrade the throughput of the other service in the best case, and in some worst case situations renders the system completely un-useable for some period of time.

This invention provides a method to resolve basic coexistence issues by preventing local and remote TX interference while receiving or transmitting addressed packets between two disparate services (Bluetooth (BT) and IEEE 802.11 (WLAN)). It resolves this problem by introducing a well-defined simple signaling interface that is used to indicate to the co-located other wireless service when either the BT or WLAN sides are actually receiving (or transmitting) a packet from its respective medium. A further embodiment provides a shared resource that provides the ability to effectively pass relevant system information between the two entities.

One goal of the system design is to allow each service to approach the data rates and latencies defined by each individual specification. However, since there will be periods in time that both services will require bandwidth at the same or very similar frequencies, communication between the two co-located services can decrease the interference seen in the RF domain. The passing of mode of operation information, time slot information, schedule information, and/or realtime status information can be used by both services to adequately make decisions about the instantaneous use of the frequency band. The other service can be local, or it can be remote yet closely located.

In operation, the Bluetooth wireless service or device informs the co-located other wireless service when Bluetooth receive (RX) slots (and even transmit (TX) slots) are planned to occur. Ideally, both Bluetooth's synchronous connection-oriented link (SCO) and asynchronous connectionless link (ACL) are implemented, though it should be noted that WLAN and slave-side Asynchronous BT cannot provide definitive information when a message will be received. Given the, knowledge by the other wireless service as to when TX and/or RX slots are to occur in the Bluetooth device, scheduling can be implemented in the other wireless service such that a transmission (TX) slot can be prevented in the WLAN when the RF time slot of the other wireless service is receiving.

Accordingly, mechanisms are employed that preferably attempt to avoid or defer transmission on one service while a receive RX slot is in progress in the other service. For the purposes of efficiency, it is preferred that transmission be deferred by the one service when receive traffic is actually addressed to the other service.

In the given embodiment, IEEE 802.11 and Bluetooth services are able to transmit simultaneously under most circumstances, as well as receive simultaneously under most circumstances. However, some applications may require the suppression of simultaneous ‘transmits’ from both services.

Use of a hard-wired interface (e.g., a 2-wire interface) between wireless services provides realtime information concerning the active state of the media and further offers system interconnection flexibility when IEEE 802.11 and BT coexist in a communications system but are not collocated on the same PCB- i.e. separate boards in the system with a defined interconnect through a specified interface such as an edge connector. Of course, the simple two-wire interface could also be leveraged in a similar manner when 802.11 and BT are co-located on the same PCB by running PCB traces.

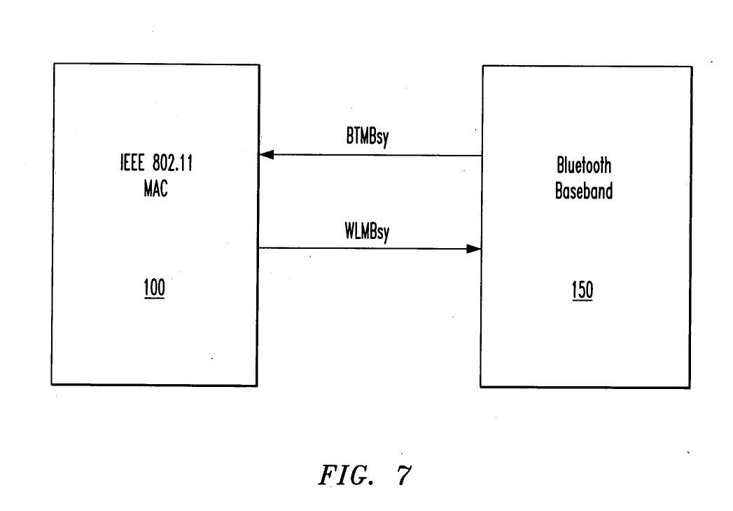

FIG. 7 shows an exemplary IEEE 802.11 radio system 100 and Bluetooth baseband equipment 150 including an exemplary hard-wired interface (e.g., a 2-wire interconnect), in accordance with the principles of the present invention.

In particular, as shown in FIG. 7, the co-existing wireless systems 100, 150 include a direct communication link therebetween comprising Bluetooth Medium Busy (BTMBsy) and WLAN Medium Busy (WLMBsy) signals.

Use of a shared resource such as a mailbox allows the disparate wireless services to pass local messages back and forth between the disparate services. General timing, QoS state, mode of operation, frequency hopping information, channel selection information, and application information, 802.11 channel information, and general device state information may be shared between the services.

Note that only BT knows in advance when TX and RX will happen, because of its RF time slot time division nature. Thus, a WLAN interface can be provided with critical information on when an RF time slot wireless service such as Bluetooth will access its media (i.e., when BT requires reception of an incoming frame, when it will transmit, how long it will require the media to be busy, etc.)

In a preferred embodiment, while in asynchronous mode, the wireless services may interrupt one another using the direct communication link (e.g., direct-wire interface, mailbox, etc.) The direct communication link may also be used to provide information relating to a timing reference point.

Moreover, the direct communication link may also be used to provide a dynamic exchange of information sufficient to allow one wireless service (e.g., a Bluetooth system) to adaptively frequency hop around radio frequency (RF) channels of another wireless service (e.g., a WLAN) as they are transmitted by the WLAN system.

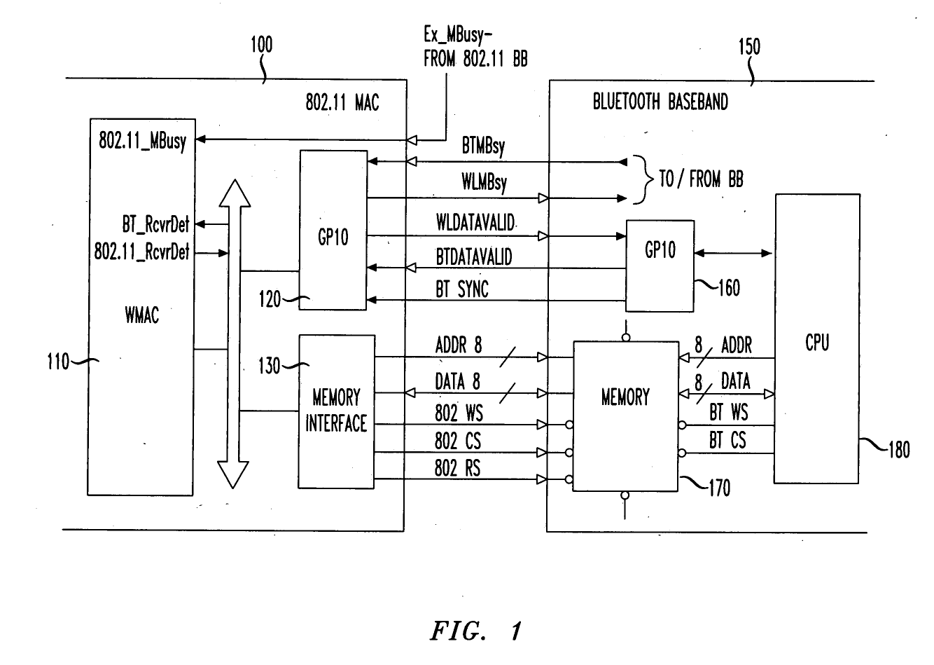

FIG. 1 shows a block diagram of one embodiment of a direct communication link established between two co-located wireless services, e.g., a Bluetooth system and an WiFi (IEEE 802.11), in accordance with the principles of the present invention.

In particular, as shown in FIG. 1, an IEEE 802.11 MAC 100 includes WMAC 110, GPIO (General Purpose Input/Output interface) 120 and memory interface 130. Similarly, the Bluetooth (BT) baseband equipment 150 includes CPU 180, GPIO 160 memory 170. The direct communication link comprises a 2-wire interface with two dedicated “xMBsy” signals. The first, “Bluetooth Medium Busy” signal BTMBsy indicates when the Bluetooth system is actually receiving a packet over its medium. The second signal “WLAN Medium Busy” WLMBsy indicates when the IEEE 802.11 WLAN is actually receiving a packet over its medium. Busy signals set up to inform when they are receiving may additionally be used to indicate when they are transmitting, in accordance with the principles of the present invention.

In the case of a direct communication link comprising a mailbox or other shared resource (i.e., memory), an event interface may be used to convey that information has been written into the shared resource. The shared resource forms a direct communication link that passes local messages back and forth between the disparate wireless services. The external event mechanism may be used as a timing reference point.

A mailbox interface can be used to convey, among other important system parameters, “No-TX Timing Window” or “No-RX Timing Window” information. This information can be shared with the WLAN system in an effort to coordinate and defer WLAN transmission during periods of known reception on the BT link. To support this mailbox a stable timing reference is required and the proposed BTSYNC signal would be the required signal to provide that stable timing source.

In this embodiment, for convenience, the shared resource is shown as being embedded in the BT transceiver. In actuality it could be located anywhere within the “local” communications system.

The interface, depicted in FIG. 1, provides two dedicated “xMBusy” signals, a pair of even signals, and a synchronization signal. The definition of these pins is:

| Signal | Pin | Function |
|---|---|---|
| BTMBsy | 1 | Active when BT is actually transmitting or |
| | | actually receiving. Inactive when |
| | | BT medium is |
| | | clear. |
| WLMBsy | 1 | Active when WLAN is actually |
| | | receiving. Inactive |
| | | when WLAN medium is clear. |
| BT_SYNC | 1 | Signal used also as a timing reference point |
| | | mechanism |
| WLDATAVALID | 1 | Indicates the validity of the WL Mailbox data |
| | | written by the IEEE 802.11 MAC, and hence |
| | | when the Bluetooth Baseband should read the |
| | | WL Mailbox. |
| BTDATAVALID | 1 | Used to indicate the validity of the BT Mailbox |
| | | data written by the Bluetooth Baseband, and |
| | | hence when the IEEE 802.11 MAC should read |
| | | the BT Mailbox. |

The basic assumption of this interface is that the WLAN side cannot predict when frames will arrive on its medium. It is noted that the WMAC can generate WLMBsy when RX frames are coming in or it is transmitting frames on the media and further can be assumed that the WMAC can also negate or turn this signal off when the IEEE 802.11-defined A1 address field says that our station is not being currently addressed (i.e. no address match, broadcast, or multi-cast packet). Under normal operating conditions for both services, the Bluetooth transmitter should defer and not actively transmit data out onto the BT medium while this signal is active. This ultimately may introduce some issues with BT link synchronization and accordingly the deferral mechanisms may be made provisional depending on current mode, and possibly how much the BT transmitter has already deferred.

Furthermore, rate reduction techniques may be preferred on the WLAN, e.g., dynamically fragmenting frames at lower rates. Given mode of operation information, the BT service can make intelligent choices as to when to ignore this signal and transmit anyway. For instance, when BT is in a quality of service (QoS) link, adherence to the QoS parameters may necessitate the transmission of BT packets at a particular instance in time regardless of the state of the 802.11 receiver.

The WLMBsy signal is driven high when the IEEE 802.11 receiver indicates a busy medium (e.g., transmitting OR receiving). Conversely, this signal should be driven low when the medium is clear.

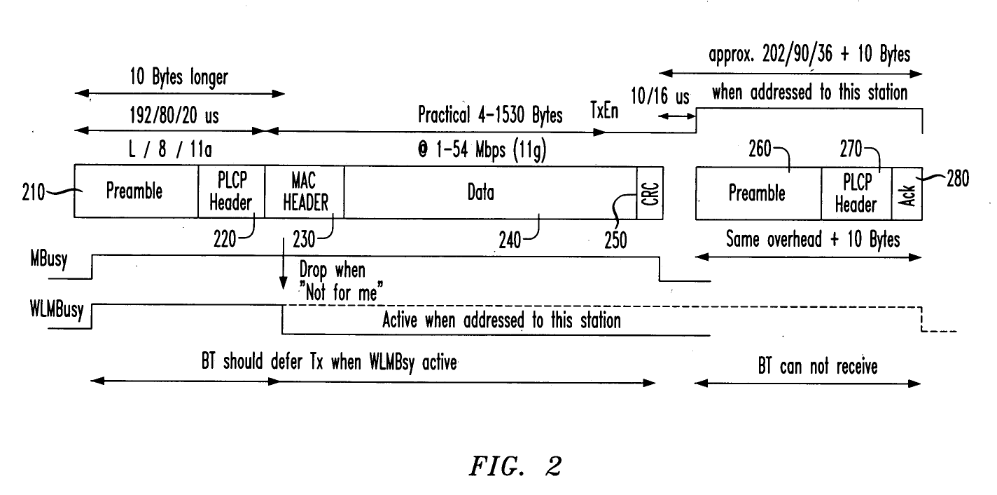

FIG. 2 shows exemplary signal timing of an exemplary WLAN Medium Busy (WLMBsy) signal, in accordance with the principles of the present invention.

In particular, as shown in FIG. 2a forward IEEE 802.11 packet includes a preamble 210, a PLCP header 220, a MAC header 230, data 240 and CRC error checking information 250. After a Short Inter-Frame Space after correct reception of a packet, an acknowledgement packet is sent, including a preamble 260, a PLCP header 270 and an acknowledgement 280. The 802.11-defined Medium Busy signal (Mbusy) is driven high during the time the forward IEEE packet is detected, and the signal WLMBsy is initially high when MBusy is high, but is driven low if the forward packet is “Not for me”, i.e. not for this transceiver. Bluetooth communications are deferred if WLMBsy is high, and no Bluetooth signals can be transmitted whilst the IEEE 802.11 acknowledgement packet is being sent.

Similarly, the BTMBsy signal can be used to force the WLAN transmitter to defer (not backoff). In this case the IEEE 802.11 WMAC will sample the BTMBsy signal just prior to the WLAN TX start, and defer if needed, sampling at slot time intervals (20μs (for 802.11b)/9 μs (for 802.11a/g)). It should be noted that a simple OR function of the IEEE 802.11 MBusy signal and the BTMBsy signal is not desirable. While the IEEE 802.11 MBusy signal is active and de-asserted a backoff timing interval counter is initiated and the IEEE 802.11 WMAC will not be able to transmit on the media until the expiry of this timer. The assertion of the BTMBsy signal implies that the BT media is busy but on the de-assertion of this signal, if the IEEE 802.11 WMAC has transmit data queued up and ready to send on the media, it should be free to do so.

The BTMBsy signal is governed by the following equation:

| | |
|---|---|
| BTMBsy = | (PreventSimTX AND TX_BUSY) |
| | OR (RX_BUSY AND RXBusyEnable) |

Where:

PreventSimTX [symbol] “Prevent Simultaneous Transmit” is a software controllable signal that will be logically high when the system requires the prevention of simultaneous transmits on the IEEE 802.11 medium and the Bluetooth medium.

-TX_BUSY [symbol] “TX BUSY” is logically high when Bluetooth transmit is active for the system.

-RX_BUSY [symbol] “RX_BUSY” is logically high when Bluetooth receive is active for the system.

-RXBusyEnable [symbol] “RXBusyEnable” is a software controllable signal that will be logically high when the Bluetooth Baseband is receiving to indicate to the IEEE 802.11 MAC that the Bluetooth receive window is open.

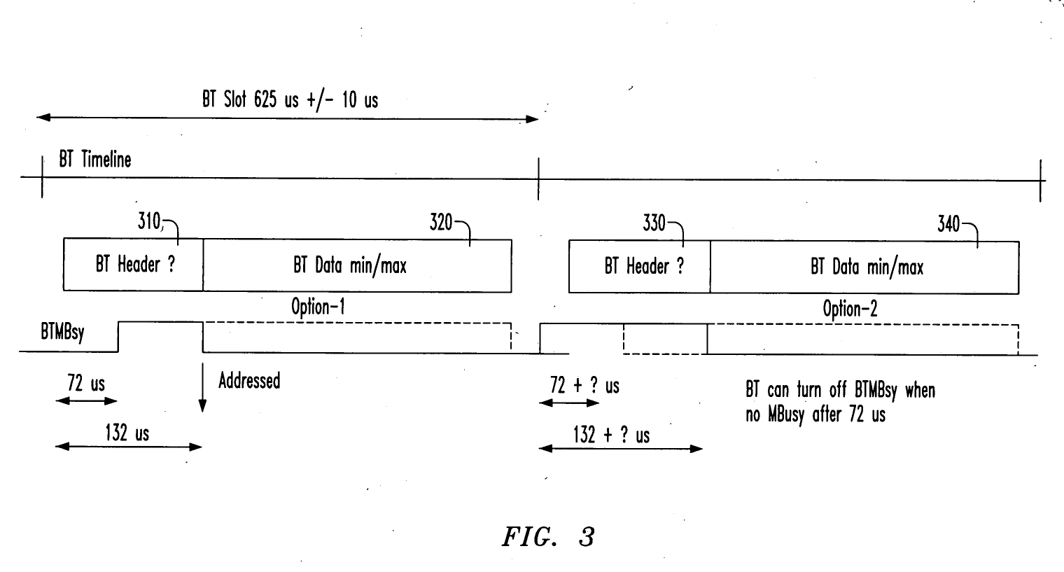

FIG. 3. shows timing of an exemplary Bluetooth BTMBsy signal while operating in asynchronous mode, in accordance with the principles of the present invention.

In particular, as shown in FIG. 3, a first Bluetooth packet includes a header 310 and data 320, and a second packet including a header 330 and data 340. The solid lines represent the BTMBsy signal in the case where the Bluetooth packets are not addressed to the BT baseband equipment, whereas the dotted lines in the BTMBsy signal show that the BTMBsy signal stays high until the end of the BT packets in the case where the BT packets are addressed to the BT baseband equipment. Two different embodiments are shown, and these are designated as Option 1 and Option 2.

In Option 1, the BTMBsy signal is driven active at 72 microseconds based upon the BT baseband equipment's knowledge that correlated data has been received. Then, upon conclusion of the header data, the BT baseband equipment can then either keep the signal active (if the received data is for it), or it can drive it inactive (low) if the received data has not been addressed to it. This embodiment has the shortcoming of not being able to reduce interference during the period of time when the BT baseband would be determining if any packets are on the medium during that slot.

In Option 2, the BTMBsy signal is driven active at the start of a BT receive slot regardless of whether or not correlated data has been received. This would be done to decrease the probability of interference during the time when the BT baseband equipment would be trying to determine if there are any packets on the medium during that slot. Then, the BTMBsy signal could be driven low at 72 microseconds if no packet is on the medium, or at the end of the header if there is a packet, but it is not for this device. If the packet comes in and is addressed for this device, then BTMBsy would be active until the end of the data.

The basic assumption of this interface is that the WLAN side cannot predict when frames will arrive. Bluetooth, however, does potentially have the capability of predicting when TX and RX will happen in advance. In this mode an event can be signaled in advance that provides the WLAN interface with critical information on when the BT link will access its media. Information such as when BT requires reception of an incoming frame, when it will transmit, as well as how long it will require the media to be busy can be signaled to the WMAC through the “mailbox” resource.

The mailbox may be considered to be one or more memory locations, and as such may be considered to be a “plurality of mailboxes” to convey that more than one memory location is used (at least one designated for each communication direction) to provide full duplex communications.

Given that the BT side is the entity that knows when frames will arrive, the use of an EVENT interface is likely to be more heavily used in the BT to WLAN direction. The passing of transmit/receive schedule information necessitates the knowledge of BT time in the WMAC. The signal that may communicate BT time to the WMAC is referred to herein as BTSYNC.

In certain times, when High Priority traffic is present on the WLAN media, it may be important to provide the BT side with traffic congestion information, but this operation likely will be fairly static. In the exemplary WMAC, latency between the rising edge of a BTSYNC event and the start of the associated processing of the information should be deterministic with an accuracy of +/− several microseconds.

The BTSYNC signal will likely become active only when the system is presently in an active Bluetooth link. To that end, the BTSYNC signal will be driven low under the following conditions:

[1] The system is not participating in a Bluetooth link; or

[2] The system is participating in a Bluetooth link that is in Park, Hold, or Sniff.

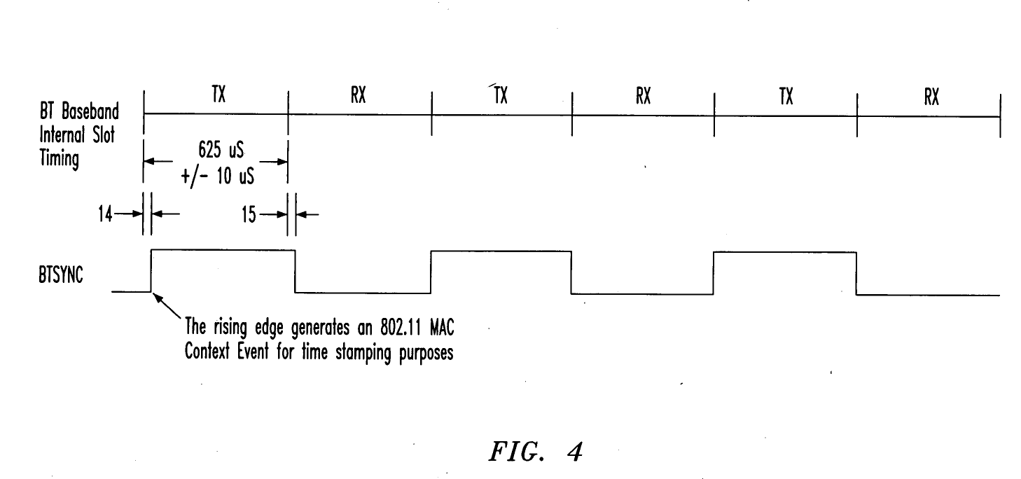

FIG. 4 shows exemplary synchronous signal timing of a Bluetooth BTSYNC signal, in accordance with the principles of the present invention.

In particular, as shown in FIG. 4, the BTSYNC signal is driven high t4 after the beginning of each Transmit (TX) period and driven low t5 after the beginning of each Receive (RX) period. xDATAVALID signals are used to signal to each service that mailbox data has arrived and/or is presently valid. The type of data that has been written to the mailbox is not important to the operation of the xDATAVALID signals.

The purpose of BTDATAVALID is to indicate the validity of the BT Mailbox data written by the Bluetooth Baseband, and hence when the IEEE 802.11 MAC should read the BT Mailbox. BTDATAVALID high means BT Mailbox data is valid, and may be read by the IEEE 802.11 MAC. BTDATAVALID low means the BT Mailbox data is not valid (is being updated), and should not be read by the IEEE 802.11.

An IEEE 802.11 MAC Event will be assumed on a rising edge of the BTDATAVALID signal. Note that the BTDATAVALID signal will be driven low by the Bluetooth Baseband while writing the BT Mailbox.

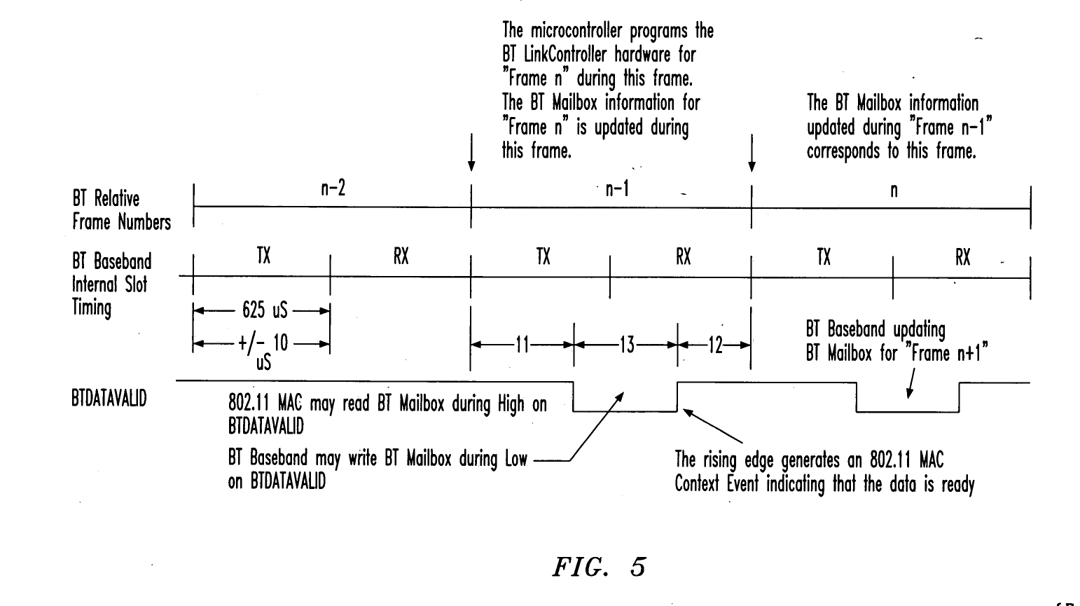

FIG. 5 shows characteristics of an exemplary BTDATAVALID signal, in accordance with the principles of the present invention.

In particular, as shown in FIG. 5, three Bluetooth frames are successively denoted n-2, n-1 and n, each including a transmit period (TX) and a receive period (RX) having durations of 625 microseconds. The BTDATAVALID signal is shown remaining high in frame n-1 for time t1, then going low for time t3 and back to high for time t2, and the same in frame n. When BTDATAVALID is high, the IEEE 802.11 MAC may read the BT mailbox. When BTDATAVALID is low during time t3, the BT baseband equipment may write to the BT mailbox, and the BT mailbox information for the next successive frame is updated.

The purpose of WLDATAVALID is to indicate the validity of the WL Mailbox data written by the IEEE 802.11 MAC, and hence indicate when the Bluetooth Baseband should read the WL Mailbox. A HIGH condition of the WLDATAVALID signal in the exemplary embodiment indicates that WL Mailbox data is valid, and thus may be read by the Bluetooth Baseband system. A LOW condition of the WLDATAVALID signal indicates that the WL Mailbox data is not valid (i.e., is being updated), and should not be read by the Bluetooth Baseband system.

In the disclosed embodiment, the WLDATAVALID signal will be driven low by the IEEE 802.11 MAC when the WMAC is writing to the WL Mailbox.

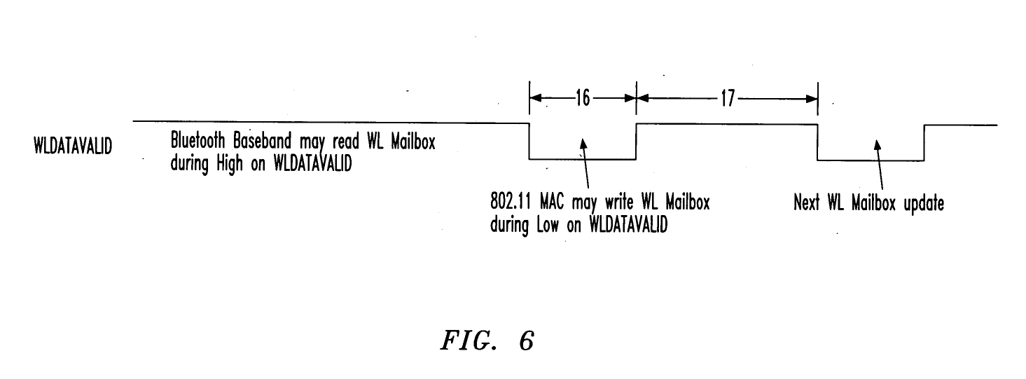

FIG. 6 shows characteristics of an exemplary BTDATAVALID signal indicating when IEEE 802.11 (WiFi) data is valid, in accordance with the principles of the present invention.

In particular, as shown in FIG. 6, the WMAC BTDATAVALID Read Protocol is as shown in the following table:

| BTDATAVALID | BTDATAVALID | | |
|---|---|---|---|
| State Before BT | State After BT | | IEEE 802.11 Mac |
| Mailbox Read | Mailbox Read | Meaning | Response |
| High | High | BT Mailbox read data | Use BT Mailbox |
| | | is valid | read data |
| High | Low | BT Mailbox read data | Do not use BT |
| | | is invalid because BT | Mailbox read data. |
| | | Baseband may have | Read BT Mailbox |
| | | updated the data | again. |
| | | during the IEEE | |
| | | 802.11 MAC read | |
| Low | X | IEEE 802.11 MAC not | Wait until |
| | | allowed to read BT | BTDATAVALID is |
| | | Mailbox | High |

US Patent Application Publication 2001/10689 A1 to Awater et al. describes a coexistence system in relation to Bluetooth voice links (SCO). The timing diagram in the Awater et al. published application refers only to HV (High-quality Voice) packets (which are the packet types for SCO links only). The present invention, while including SCO links, proposes coexistence for Bluetooth Asynchronous Connection-Less (ACL) links as well.

This invention provides a means by which two co-located, to disparate wireless systems can avoid interference with one another by including a direct communication link therebetween to generically exchange state information. Exemplary state information includes, but is not limited to, e.g., exchanging scheduling information, mode of operation information, 802.11 channel usage information, and/or device state information. The 802.11 channel usage information may be used, e.g., to allow adaptive frequency hopping by a Bluetooth system around the 802.11 channels in use at the same time.

The direct communication interface described herein allows each disparate wireless service to make intelligent decisions on common or close frequency band usage.

The solutions described herein may be implemented in a straightforward manner, e.g., by dedicating a number of pins to support a hard-wired direct communication link, thereby permitting operable coexistence between BT and IEEE 802.11 transceivers.

While the invention has been described with reference to the exemplary embodiments thereof, those skilled in the art will be able to make various modifications to the described embodiments of the invention without departing from the true spirit and scope of the invention.

What is claimed is:

1. A method of avoiding transmission interference between a first wireless system operating at a first range of frequencies of operation and a second wireless system operating at a second range of frequencies of operation, said first wireless system and said second wireless system being co-located, said method comprising:
passing radio status information from said first wireless system to said second wireless system;
delaying transmission by said second radio system based on medium status information provided by said first wireless system;
wherein one of said first wireless system and said second wireless system transmits in RF time slots; and
wherein concurrent radio transmission by both said first wireless system and said second wireless system is avoided.

2. The method of avoiding transmission interference between a first wireless system operating at a first range of frequencies of operation and a second wireless system operating at a second range of frequencies of operation, said first wireless system and said second wireless system being co-located according to claim 1, wherein:
a first range of radio frequencies used by said first wireless system overlap at least in part a second range of radio frequencies used by said second wireless system.

3. The method of avoiding transmission interference between a first wireless system operating at a first range of frequencies of operation and a second wireless system operating at a second range of frequencies of operation, said first wireless system and said second wireless system being co-located according to claim 1, further comprising:
passing radio status information from said second wireless system to said first wireless system.

4. The method of avoiding transmission interference between a first wireless system operating at a first range of frequencies of operation and a second wireless system operating at a second range of frequencies of operation, said first wireless system and said second wireless system being co-located according to claim 1, wherein:
said radio status information includes a timing of a transmission.

5. The method of avoiding transmission interference between a first wireless system operating at a first range of frequencies of operation and a second wireless system operating at a second range of frequencies of operation, said first wireless system and said second wireless system being co-located according to claim 1, wherein said radio status information comprises:
a timing of a receive operation.

6. The method according to claim 1, wherein said radio status information comprises:
frequency hopping information.

7. The method according to claim 1, wherein said radio status information comprises:
IEEE 802.11 channel information.

8. The method of avoiding transmission interference between a first wireless system operating at a first range of frequencies of operation and a second wireless system operating at a second range of frequencies of operation, said first wireless system and said second wireless system being co-located according to claim 1, wherein:
said first wireless system is a piconet.

9. The method of avoiding transmission interference between a first wireless system operating at a first range of frequencies of operation and a second wireless system operating at a second range of frequencies of operation, said first wireless system and said second wireless system being co-located according to claim 1, wherein:
said second wireless system is a WLAN.

10. The method of avoiding transmission interference between a first wireless system operating at a first range of frequencies of operation and a second wireless system operating at a second range of frequencies of operation, said first wireless system and said second wireless system being co-located according to claim 1, wherein:
said first wireless system is a piconet; and
said second wireless system is a WLAN.

11. The method of avoiding transmission interference between a first wireless system operating at a first range of frequencies of operation and a second wireless system operating at a second range of frequencies of operation, said first wireless system and said second wireless system being co-located according to claim 1, wherein:
said piconet is a BLUETOOTH piconet; and
said WLAN is an IEEE 803.11 WLAN.

12. A device incorporating a first wireless system operating at a first range of frequencies of operation and a second wireless system operating at a second range of frequencies of operation, said first wireless system and said second wireless system being co-located, comprising:
a first busy signal provided by said first wireless system to said second wireless system over a direct communication link indicating a timing of a reception on said first wireless system;
a second busy signal provided by said second wireless system to said first wireless system over a direct communication link indicating a timing of a reception on said second wireless system; and
a controller responsive to said first busy signal, said controller being configured to cause said second wireless system to delay transmission due to an active transmission state of said first wireless system;
wherein one of said first wireless system and said second wireless system transmits in RF time slots.

13. The device incorporating a first wireless system operating at a first range of frequencies of operation and a second wireless system operating at a second range of frequencies of operation, said first wireless system and said second wireless system being co-located according to claim 12, wherein said direct communication link comprises:
a common resource forming a mailbox between said first wireless system and said second wireless system.

14. The device incorporating a first wireless system operating at a first range of frequencies of operation and a second wireless system operating at a second range of frequencies of operation, said first wireless system and said second wireless system being co-located according to claim 12, wherein said direct communication link comprises:
a hard-wired interface between said first wireless system and said second wireless system.

15. The device incorporating a first wireless system operating at a first range of frequencies of operation and a second wireless system operating at a second range of frequencies of operation, said first wireless system and said second wireless system being co-located according to claim 14, wherein said hard-wired interface comprises:
a 2-wire bi-directional interface.

16. The device incorporating a first wireless system operating at a first range of frequencies of operation and a second wireless system operating at a second range of frequencies of operation, said first wireless system and said second wireless system being co-located according to claim 12, wherein:
said first wireless system includes a Bluetooth radio front end; and
said second wireless system includes an IEEE 802.11 radio front end.

17. The device incorporating a first wireless system operating at a first range of frequencies of operation and a second wireless system operating at a second range of frequencies of operation, said first wireless system and said second wireless system being co-located according to claim 16, wherein:
said first wireless system generates a Bluetooth synchronization signal, said synchronization signal controlling a multiplexing of IEEE 802.11 packets between active time slots of said first wireless system.

18. The device incorporating a first wireless system operating at a first range of frequencies of operation and a second wireless system operating at a second range of frequencies of operation, said first wireless system and said second wireless system being co-located according to claim 12, wherein said controller comprises:
at least one mailbox for exchanging information between said first wireless system and said second wireless system.

19. A method for co-locating a first wireless system operating at a first range of frequencies of operation and a second wireless system operating at a second range of frequencies of operation, comprising:
providing a first busy signal by said first wireless system to said second wireless system over a direct communication link indicating a timing of active reception on said first wireless system;
providing a second busy signal by said second wireless system to said first wireless system over said direct communication link indicating a timing of active reception on said second wireless system; and
a controller responsive to said first busy signal, said controller being configured to cause said second wireless system to delay transmission due to an active transmission state of said first wireless system;
wherein one of said first wireless system and said second wireless system transmits in RF time slots.

20. The method for co-locating a first wireless system operating at a first range of frequencies of operation and a second wireless system operating at a second range of frequencies of operation, according to claim 19, wherein said direct communication link comprises:
a common resource forming a mailbox between said first wireless system and said second wireless system.

21. The method for co-locating a first wireless system operating at a first range of frequencies of operation and a second wireless system operating at a second range of frequencies of operation, according to claim 19, wherein said direct communication link comprises:
a hard-wired interface between said first wireless system and said second wireless system.

22. The method for co-locating a first wireless system operating at a first range of frequencies of operation and a second wireless system operating at a second range of frequencies of operation, according to claim 21, wherein said hard-wired interface comprises:
a 2-wire bi-directional interface.

23. The method for co-locating a first wireless system operating at a first range of frequencies of operation and a second wireless system operating at a second range of frequencies of operation, said first wireless system and said second wireless system being co-located according to claim 19, wherein:
said first wireless system includes a Bluetooth radio front end; and
said second wireless system includes an IEEE 802.11 radio front end.

24. The method for co-locating a first wireless system operating at a first range of frequencies of operation and a second wireless system operating at a second range of frequencies of operation, said first wireless system and said second wireless system being co-located according to claim 19, further comprising:
providing at least one mailbox for exchanging information between said first wireless system and said second wireless system.
